(19) United States
(12) Patent Application Publication
(10) Pub. No.: US 2024/0045772 A1
(43) Pub. Date: Feb. 8, 2024

(54) CONTINUOUS DATA PROTECTION UNIT, RECOVERY UNIT FOR DATA PROTECTION AND METHOD THEREOF

(71) Applicant: Huawei Technologies Co., Ltd., Shenzhen (CN)

(72) Inventor: Assaf Natanzon, Hod Hasharon (IL)

(21) Appl. No.: 18/339,679

(22) Filed: Jun. 22, 2023

Related U.S. Application Data
(63) Continuation of application No. PCT/EP2020/087834, filed on Dec. 23, 2020.

(51) Int. Cl. G06F 11/14

(52) U.S. Cl. CPC G06F 11/1466; G06F 11/1451

(57) ABSTRACT

A continuous data protection unit (CDP unit) is arranged to receive from a primary splitter, a copy of incoming data sent to a primary storage in the form of incoming change sets. The CDP unit comprises CDP data mover, and CDP storage unit. The CDP data mover is arranged to receive the incoming change sets and write recovery data based on one or more change sets to the CDP storage unit and to a recovery unit arranged to hold a copy of the recovery data.

### CROSS-REFERENCE TO RELATED APPLICATIONS

This application is a continuation of International Application No. PCT/EP2020/087834, filed on Dec. 23, 2020, which is hereby incorporated by reference in their entireties.

### TECHNICAL FIELD

The present disclosure relates generally to the field of data backup and disaster recovery; and more specifically, to a continuous data protection unit, recovery unit and a method of data protection.

### BACKGROUND

Generally, data backup is used to protect and recover data in an event of data loss in a primary storage (e.g. a block storage device). Examples of the event of data loss may include, but is not limited to, data corruption, hardware or software failure in the primary storage, accidental deletion of data, hacking, or malicious attack. For safety reasons, a separate backup system or a secondary storage is extensively used to store a backup of the data present in the primary storage. Typically, with time, storage space of the secondary storage becomes occupied as changes in data or any new data occupy a large storage space in such secondary storages. This is undesirable as it causes reduction in performance of the secondary storage. Moreover, the cost of data storage, with all the associated costs including cost of storage hardware, continues to be a burden.

In some implementations, a snapshot of the data in primary storage is periodically taken and compared with the previous snapshot of the data in the primary storage. Further, only difference of the two snapshots is read from the recent snapshot and sent to the secondary storage. However, as the snapshots are computational resource intensive, they are cost inefficient and usually undesirable for the primary storage. Further, the snapshots are temporary and deleted frequently which makes process even more computational resource intensive. This is one of the prominent reasons why the snapshots are not taken very frequent resulting in larger recovery point objective (RPO). A larger RPO may result in inefficient transfer of data from the secondary storage to the primary storage in-case of data loss. Further, when the snapshots are mounted on an array, to be read by the secondary storage, the snapshots reduce the bandwidth that is provided by the array to production workloads. In another implementation, continuous data protection (CDP) is used in which a splitter intercepts the received data for primary storage and mirrors the received data to a data mover in the secondary storage. However, there are several limitations associated with such an implementation. There is a requirement of higher bandwidth and since the data is mirrored in real-time, the bandwidth is often fluctuated due to peaks of data. Thus, this implementation which is used for storing data in secondary storage depends on the workload and need of data capacity for storage and performance. If CDP is used to transfer data to a cloud then all the data continuously transfers to the cloud, however the problem is the bandwidth fluctuations. Generally, when writing data to a local secondary storage, bandwidth is high but when writing to the cloud, bandwidth may be lower. Moreover, when the RPO for the secondary storage and the cloud storage is same, bandwidth fluctuation can cause error when transferring data to the cloud and not being able to keep the continuous replication to the cloud. For example, the secondary storage may not provide backup data of last few hours based on frequency of data backup to secondary storage.

Therefore, in light of the foregoing discussion, there exists a need to overcome the aforementioned drawbacks associated with conventional data backup having CDP.

### SUMMARY

The present disclosure seeks to provide a continuous data protection (CDP) unit, recovery unit, data protection assembly and a method of data protection. The present disclosure seeks to provide a solution to the existing problem of same recovery point objective (RPO) for CDP and a cloud storage associated with CDP which results in a risk of data loss and also inefficient as well as error-prone retrieval of data to a primary storage. An aim of the present disclosure is to provide a solution that overcomes at least partially the problems encountered in prior art, and provide improved data backup and retrieval by having variable recovery point objective in the CDP and the cloud storage associated with CDP.

The object of the present disclosure is achieved by the solutions provided in the enclosed independent claims. Advantageous implementations of the present disclosure are further defined in the dependent claims.

In one aspect, the present disclosure provides a continuous data protection unit-—CDP unit—arranged to receive from a primary splitter, a copy of incoming data sent to a primary storage in the form of incoming change sets, said CDP unit comprising a CDP data mover, and a CDP storage unit, the CDP data mover being arranged to receive the incoming change sets and write recovery data based on one or more change sets to the CDP storage unit and to a recovery unit arranged to hold a copy of the recovery data.

The CDP unit and the recovery unit of the present disclosure provides improved data backup, data safety, and retrieval by having variable RPO in for the CDP unit and the recovery unit. The RPO for the CDP unit and the recovery unit may be improved (e.g. optimized) based on requirement. The RPO for the recovery unit is varied based on the way data is written to the recovery unit. The data may be sent to the recovery unit directly by the CDP unit to have a low RPO for the recovery unit. Further, the data may be first sent to the CDP journal unit and then read from the CDP journal by applying write coalescing and then the data is sent to the recovery unit to have a higher RPO for the recovery unit. Further, the change set can be read in a consolidated way from the CDP storage unit to enable significant saving of bandwidth. Thus, the present disclosure enables efficient transfer of data from the CDP unit and the recovery unit to the primary storage in-case of data loss in the primary storage.

In an implementation form, the CDP data mover is arranged to forward the incoming

change sets as recovery data to the recovery unit.

The CDP data mover forwards the incoming change sets as recovery data to recovery unit in different ways to have different (or variable) recovery point objectives for the CDP unit and the recovery unit.

In a further implementation form, the CDP data mover is arranged to create the recovery data by coalescing data from two or more CDP change sets.

By virtue of coalescing data from two or more CDP change sets there is significant saving of bandwidth for the CDP unit which further makes computing process efficient.

In a further implementation form, a CDP journal unit arranged to temporarily store the incoming change sets, wherein the CDP data mover is arranged to forward the incoming data sets to the CDP journal unit, the CDP data mover being further arranged to read one or more of the incoming change sets from the CDP journal unit and the recovery data is based on the one or more CDP change sets.

By virtue of forwarding data to the CDP journal unit and then reading from the CDP journal unit, the incoming change sets are consolidated using write coalescing. As a result, there is significant saving of bandwidth for the CDP unit.

In a further implementation form, the CDP unit comprises one or more CDP snapshots of the CDP storage unit, each CDP snapshot being a copy of the CDP storage unit at a specific point in time, wherein CDP data mover is arranged to create the recovery data based on data from at least one of said one or more CDP snapshots.

The CDP snapshots store the data for different points in time. Thus, the CDP unit can consolidate data for several hours and then send to the recovery unit to enable saving of bandwidth.

In another aspect, the present disclosure provides a recovery unit for data protection, said recovery unit comprising a recovery unit journal configured to receive recovery data from a CDP data mover in a CDP unit, a recovery unit data mover arranged to receive the recovery data from the recovery unit journal, and a recovery unit storage arranged to hold a copy of the recovery data.

The recovery unit and CDP unit of the present disclosure provides improved data backup and retrieval by having variable RPO in for the recovery unit and the CDP unit. The RPO for the CDP unit and the recovery unit may be optimized based on the requirement. The RPO for the recovery unit is varied based on the way data is written to the recovery unit. The data may be sent to the recovery unit directly by the CDP unit to have a low RPO for the recovery unit. Further, the data may be first sent to the CDP journal unit and then read from the CDP journal by applying write coalescing and then the data is sent to the recovery unit to have a higher RPO for the recovery unit. Further, the change set can be read in a consolidated way from the CDP storage unit to enable significant saving of bandwidth. Thus, the present disclosure enables efficient transfer of data from the CDP unit and the recovery unit to the primary storage in-case of data loss in the primary storage.

In an implementation form, the recovery unit further comprises one or more recovery unit snapshot units arranged to hold momentary snapshots of the recovery unit storage.

The recovery unit snapshot units store the data of recovery unit storage for different points in time. Thus, in-case of data retrieval to the primary storage, the data can be retrieved of different points in time.

In another aspect, the present disclosure provides a data protection assembly, comprising a CDP unit and a recovery unit, wherein the CDP data mover is arranged to forward the recovery data to the recovery unit data mover.

The data protection assembly comprising the recovery unit and the CDP unit provides improved data backup and retrieval by having variable RPO in for the recovery unit and the CDP unit. The data protection assembly achieves all the advantages and effects of the CDP unit and the recovery unit of the present disclosure.

In another aspect, the present disclosure provides a data protection method, involving a CDP unit comprising a CDP data mover and a CDP storage unit, said method comprising the steps of receiving incoming data from a primary splitter to the CDP data mover in the form of one or more incoming change sets. The method further comprises forwarding recovery data based on the input change sets from the CDP data mover to the CDP storage unit and to a recovery unit arranged to hold a copy of the recovery data.

In the data protection method, the recovery unit and the CDP unit provides improved data backup and retrieval by having variable RPO in for the recovery unit and the CDP unit. The data protection method achieves all the advantages and effects of the CDP unit and the recovery unit of the present disclosure.

In a further implementation form, the CDP unit further comprises a CDP journal unit, the method further comprising the steps of writing the incoming change sets from the CDP data mover to the CDP journal unit, reading one or more of the incoming change sets from the CDP journal unit by the CDP data mover, creating, in the CDP data mover, the recovery data based on the one or more incoming change sets read from the CDP journal unit.

By virtue of forwarding data to the CDP journal unit and then reading from the CDP journal unit, the incoming change sets are consolidated using write coalescing. As a result, there is significant saving of bandwidth for the CDP unit.

In a further implementation form, the CDP unit further comprises one or more snapshots of the CDP storage unit, each CDP snapshot being a copy of the CDP storage unit at a specific point in time, the method further comprising the steps of reading, by the CDP data mover, at least one of the snapshots and creating the recovery data based on data from at least one snapshot, for example by determining the difference between two snapshots taken at different points in time or calculating the difference between the last copy of a recovery unit snapshot unit arriving at the recovery unit and the CDP snapshot.

The CDP snapshots store the data for different points in time. Thus, the CDP unit can consolidate data for several hours and then send to the recovery unit to enable saving of bandwidth.

In another aspect, the present disclosure provides a computer program product for controlling a CDP storage unit, said computer program product comprising computer-readable code means which, when executed in a control unit will cause the control unit to control the CDP storage unit to perform the method of the previous aspect.

By virtue of the computer program product, the CDP unit and the recovery unit provides improved data backup and retrieval by having variable RPO in for the recovery unit and the CDP unit. The computer program product achieves all the advantages and effects of the CDP unit and the recovery unit of the present disclosure.

In a further implementation form, a computer program product for controlling a data protection assembly, said computer program product comprising computer-readable code means which, when executed in a control unit will cause the control unit to control the CDP storage unit to perform the method of the previous aspect.

By virtue of the computer-readable code in the computer program product, the CDP unit and the recovery unit provides improved data backup and retrieval by having variable RPO in for the recovery unit and the CDP unit.

In a further implementation form, a control unit for a CDP storage unit comprising a program memory holding a computer program product of the previous aspect.

The computer program achieves all the advantages and effects of the CDP unit of the present disclosure.

It is to be appreciated that all the aforementioned implementation forms can be combined. It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram that illustrates a continuous data protection unit, in

accordance with an embodiment of the present disclosure;

FIG. 2 is a block diagram that illustrates a recovery unit for data protection, in

accordance with an embodiment of the present disclosure;

FIG. 3 is a block diagram that illustrates a data protection assembly, in accordance

with an embodiment of the present disclosure;

FIG. 4 is a flowchart of a data protection method, in accordance with an embodiment

of the present disclosure; and

FIG. 5 is an illustration of a data protection assembly, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF ILLUSTRATIVE EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

FIG. 1 is a block diagram that illustrates a continuous data protection unit, in accordance with an embodiment of the present disclosure. With reference to FIG, 1, there is shown the continuous data protection unit (CDP unit) loft The continuous data protection unit 100 comprises a CDP data mover 102 and a CDP storage unit 104. The continuous data protection unit 100 further comprises a CDP journal unit 106. There is further shown a recovery unit 108 and a primary splitter 110.

In one aspect, the present disclosure provides a continuous data protection unit—CDP unit 100 arranged to receive from a primary splitter 110, a copy of incoming data sent to a primary storage in the form of incoming change sets, said CDP unit 100 comprising a CDP data mover 102, and a CDP storage unit 104, the CDP data mover 102 being arranged to receive the incoming change sets and write recovery data based on one or more change sets to the CDP storage unit 104 and to a recovery unit 108 arranged to hold a copy of the recovery data.

The continuous data protection unit 100 is arranged to receive from a primary splitter 110, a copy of incoming data sent to a primary storage in the form of incoming change sets. The continuous data protection unit 100 is hardware, software, firmware or a combination of these for providing the continuous data protection services to data storage system. The CDP unit 100 is configured to store the incoming change sets received from the primary splitter 110 and further provide the incoming change sets to the computing system when needed. In an example, the incoming change sets herein refers to a data which is new in comparison to previously stored data or an updated data in comparison to previously stored data. Examples of incoming change sets may include, but is not limited to input/output (I/O) write request data, data received by a block storage, and the like, which may be new in comparison to previously stored data in the CDP unit 100.

The primary splitter 110 is an input/output filter software (e.g., a driver) that may be installed on a data path between for example a hypervisor and the primary storage. In other words, all the input/output is streamed through the primary splitter 110. In an example, the primary splitter 110 may be installed anywhere in the data path inside a bare-metal server, when a complete server is protected. In another example, the primary splitter 110 may be installed inside a guest Virtual Machine (VM) kernel, when the guest VM is protected. In another example, the primary splitter 110 may be installed inside a hypervisor kernel, intercepting the input/outputs of all the VM's vDisks. In another example, the primary splitter 110 may be installed inside a storage array intercepting all the input/outputs at their endpoint. The primary splitter 110 intercepts the received input/outputs (i.e. incoming data) and mirrors them (in form of incoming change sets) to a data mover for example a CDP data mover 102 in the CDP unit 100. The protocol between the primary splitter 110 and the CDP unit 100 can be synchronous, or asynchronous. When the protocol is synchronous, the primary splitter 110 holds the input/output, sends a copy to the CDP unit 100, waits for acknowledgement and only then it is received lets the input/output continue the data path. When the protocol is asynchronous, the primary splitter 110 accumulates input/outputs and periodically (for example every 5 seconds) sends them packaged within one object to the CDP unit 100, without waiting for acknowledgements. The primary storage may include a suitable logic, circuitry, and interfaces that may be configured to store the incoming data. Examples of implementation of the primary storage may include, but are not limited to, a server, a production environment system, a thin client connected to the server, a primary storage system, and user devices, such as a computing device. A backup of the incoming data in the primary storage is stored in the CDP unit 100 and the recovery unit 108 to enable recovery of data in case of data loss in primary storage.

The CDP data mover 102 is arranged to receive the incoming change sets and write recovery data based on one or more change sets to the CDP storage unit 104 and to a recovery unit 108 arranged to hold a copy of the recovery data. The CDP data mover 102 is an appliance or a micro-service which receives the input/outputs from the primary splitter 110 and sends the input/outputs to the CDP storage unit 104 and to the recovery unit 108 in for example a recovery unit journal. The CDP storage unit 104 includes suitable logic, circuitry, and interfaces that may be configured to store the incoming change sets. The incoming change sets that are received by the CDP unit 100 is used to recover data in case of any data corruption, hardware or software failure in the primary storage, accidental deletion of data, hacking, or malicious attack and thus the one or more incoming change sets are written as the recovery data. The recovery data is written to the CDP storage unit 104 and the copy of recovery data is written to the recovery unit 108 to enable variable recovery point objective (RPO) for CDP unit 100 and the recovery unit 108, and further enables a significant saving of bandwidth. The RPO for CDP unit 100 may be referred to as local RPO. The recovery unit 108 herein refers to a storage such as a cloud storage which stores the copy of recovery data. In other words, the recovery data is replicated to the recovery unit 108.

The RPO may be referred to as an interval of time up till which loss of data is acceptable by a user or an organization associated with a user device or network of user devices storing a backup of data in the CDP unit 100. In other words, RPO is the amount of data the system may lose in case of a failure, i.e. if the RPO is one hour, in case of a failure data from the last hour before the failure may be lost.

The CDP unit 100 may further include a control unit 112. The control unit 112 may also be referred to as a controller, such as a processor. The control unit 112 may include computer-readable code means which, when executed in the control unit 112 causes the control unit 112 to control the CDP storage unit 104. The control unit 112 for the CDP storage unit 104 comprises a program memory 114. The program memory 114 is configured to hold a computer program product.

According to an embodiment, the CDP data mover 102 is arranged to create the recovery data by coalescing data from two or more CDP change sets. The CDP data mover 102 is configured to apply write-coalescing (may also be referred to as smart write-coalescing) wherein a batch of change sets is consolidated into one change-set, that is much smaller than the batch. Beneficially, if a particular block range is overwritten multiple times, only the most recent written data is used to create the recovery data. This significantly reduces the amount of changes and saves bandwidth.

According to an embodiment, the CDP unit 100 further comprises the CDP journal unit 106 arranged to temporarily store the incoming change sets, wherein the CDP data mover 102 is arranged to forward the incoming data sets to the CDP journal unit 106, the CDP data mover 102 being further arranged to read one or more of the incoming change sets from the CDP journal unit 106 and the recovery data is based on the one or more CDP change sets. The CDP journal unit 106 may also be referred to as a CDP journal. The CDP journal unit 106 is configured to store the log of changes applied to the incoming data change sets. The temporary storing of the incoming change sets enables the CDP data mover 102 to execute the write-coalescing on the two or more incoming change sets. Further, based on the one or more CDP change sets on which write-coalescing is executed, the recovery data is created for the recovery unit 108. As a result, there is significant saving of bandwidth for the CDP unit. The journal is also used to allow any point in time recovery. By applying journal data to a snapshot of a previous point in time a more recent point in time may be obtained, as well as a fine granular access to points in time.

According to an embodiment, the CDP unit 100 comprises one or more CDP snapshots of the CDP storage unit 104, each CDP snapshot being a copy of the CDP storage unit 104 at a specific point in time, wherein CDP data mover 102 is arranged to create the recovery data based on data from at least one of said one or more CDP snapshots. The CDP snapshot refers to a full copy of the CDP storage unit 104 at various points in time to allow recovery to multiple points in time. In an example, CDP snapshots may be created on every hour or every 3 hours or every 6 hours and the like. Thus, recovery of data is enabled based on the CDP snapshots. The CDP data mover 102 creates the recovery data for sending to the recovery unit 108 from at least one of the one or more CDP snapshots. Thus, the CDP unit 100 can consolidate data for several hours and then send to the recovery unit 108 to enable saving of bandwidth. Leveraging snapshots allows reading the data directly from a volume (i.e. data) and not from CDP journal unit 106.

According to an embodiment, the CDP data mover 102 is arranged to forward the incoming change sets as recovery data to the recovery unit 108. The CDP data mover 102 forwards the incoming change sets as recovery data to recovery unit in different ways to have different recovery point objective for the CDP unit 100 and the recovery unit 108. The incoming change sets are forwarded as recovery data to the recovery unit 108 to enable recovery in case of a disaster such as cyber-attacks or data corruption. In an example, a full copy of the recovery data is archived for very long periods of time in the recovery unit 108. In another example, a copy of the data is continuously kept and updated in the recovery unit 108 to enable recovery in case of a disaster such as cyber-attacks or data corruption. Such an arrangement of CDP unit 100 and the recovery unit 108 may be referred to as cascaded CDP unit.

There are multiple ways for sending change sets to the recovery unit 108. In an example, a change set may be sent to the recovery unit 108 directly before it is written to the CDP journal unit 106, as a result a low RPO is obtained. In another example, a change set may be sent to the recovery unit 108 after a set of change sets is read from the CDP journal unit 106 and consolidated using write coalescing, parallel to writing the change set to the CDP storage unit 104. In another example, a change set may be read from the CDP snapshot, in this case the change set can be consolidation of several hours of change sets in the CDP journal unit 106.

Similar to the CDP unit 100, the recovery unit 108 may further include a recovery unit journal, a recovery unit data mover, and a recovery unit storage. Thus, the recovery unit 108 may also have a RPO also referred to as remote RPO.

Thus, in the present disclosure configuration of the local RPO of the CDP unit 100 and the remote RPO of the recovery unit 108 is enabled such that the remote RPO of the recovery unit 108 can be any arbitrary multiple of the local RPO (i.e. how many change sets are consolidated before sending the data to the recovery unit 108). The consolidation allows significant saving of bandwidth.

This cascaded CDP unit, allows smooth transition from moving data continuously to reading the data from the CDP snapshots. Reading data from the CDP snapshots allow creating of more sequential workload which allows data deduplication at the CDP unit 100 as well as less load on the CDP unit 100. In case the CDP unit 100 transfers the data to the recovery unit 108 from the CDP snapshot, the changes which are not transferred can be tracked either by obtaining the difference from the first snapshot or by maintaining a bitmap of the changes. Since the data is also kept in the CDP journal unit 106, at any point the CDP unit 100 may move to transferring data from the CDP journal unit 106 to the recovery unit 108, allowing full dynamic control over the local RPO of the CDP unit 100.

The CDP unit 100 and the recovery unit 108 of the present disclosure provides improved data backup and retrieval by having variable RPO in for the CDP unit 100 and the recovery unit 108. The RPO for the CDP unit 100 and the recovery unit 108 may be optimised based on the requirement. The RPO for the recovery unit 108 is varied based on the way data is written to the recovery unit 108. The data may be sent to the recovery unit 108 directly by the CDP unit 100 to have a low RPO for the recovery unit 108. Further, the data may be first sent to the CDP journal unit 106 and then read from the CDP journal unit 106 by applying write coalescing and then the data is sent to the recovery unit 108 to have a higher RPO for the recovery unit 108. Further, the change set can be read in a consolidated way from the CDP storage unit 106 to enable significant saving of bandwidth. Thus, the present disclosure enables efficient transfer of data from the CDP unit 100 and the recovery unit 108 to the primary storage in-case of data loss in the primary storage. For example, if the RPO at the recovery unit is higher, data may be written to the CDP storage unit every 1 minute, but sent to the recovery unit every 5 minutes.

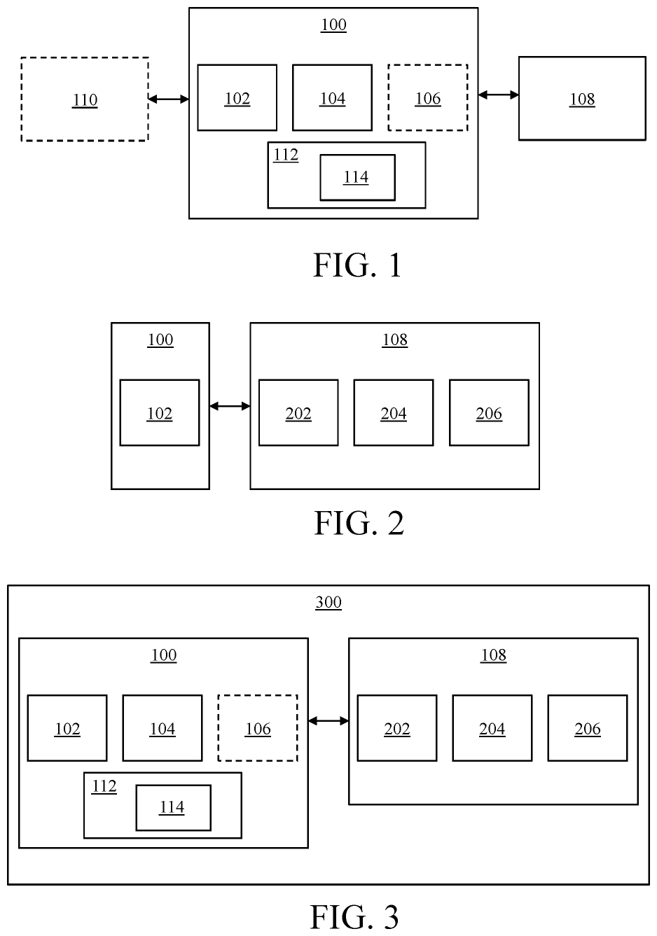

FIG. 2 is a block diagram that illustrates a recovery unit for data protection, in accordance with an embodiment of the present disclosure. With reference to FIG, 2, there is shown the recovery unit 108. The recovery unit 108 comprises a recovery unit journal 202, recovery unit data mover 204 and recovery unit storage 206. There is further shown the CDP unit 100 comprising CDP data mover 102.

In another aspect, the present disclosure provides a recovery unit 108 for data protection, said recovery unit comprising a recovery unit journal 202 configured to receive recovery data from a CDP data mover 102 in a CDP unit 100, a recovery unit data mover 204 arranged to receive the recovery data from the recovery unit journal 202, and a recovery unit storage 206 arranged to hold a copy of the recovery data.

The recovery unit 108 refers to hardware, software, firmware or a combination of these for storing data (i.e. recovery data) provided by the CDP unit 100 from for example a computing system. The recovery unit 108 may also be referred to as a cloud storage. In an example, the recovery unit 108 is configured to store a full copy of the recovery data for very long periods of time. In another example, the recovery unit 108 is configured to continuously store and update a copy of the data to enable recovery in case of a disaster such as cyber-attacks or data corruption.

The recovery unit journal 202 is configured to receive recovery data from a CDP data mover 102 in a CDP unit 100. Based on the received recovery data, the recovery unit journal 202 is configured to store the log of changes applied to the recovery data. There may be multiple ways for receiving recovery data by the recovery unit journal 202. In an example, a change set received by CDP unit 100 may be sent to the recovery unit 108 directly as recovery data, before it is written to the CDP journal unit 106. In another example, a change set may be sent to the recovery unit 108 as recovery data, after a set of change sets is read from the CDP journal unit 106 and consolidated using write coalescing at the CDP unit 100. In another example, a change set may be read from the CDP snapshot by the CDP data mover 102 and then sent to the recovery unit journal 202.

The recovery unit data mover 204 is arranged to receive the recovery data from the recovery unit journal 202. In other words, the recovery unit data mover 204 reads the recovery data from the recovery unit journal 202 and applies them to a recovery unit replica i.e. the copy of recovery data in the recovery unit 108.

The recovery unit storage 206 is arranged to hold a copy of the recovery data. The recovery unit storage 206 includes suitable logic, circuitry, and interfaces that may be configured to store the recovery data. Examples of implementation of the recovery unit storage 206 may include, but are not limited to, Electrically Erasable Programmable Read-Only Memory (EEPROM), Random Access Memory (RAM), Read Only Memory (ROM), Hard Disk Drive (HDD), Flash memory, Solid-State Drive (SSD), or CPU cache memory.

According to an embodiment, the data may be sent from the CDP data mover 102 to recovery unit data mover 204, where the remote data mover 204 writes to recovery unit journal 202, and later the remote data mover 204 reads from the recovery unit journal 202 and writes to the recovery unit storage 206.

According to an embodiment, the recovery unit 108 further comprises one or more recovery unit snapshot units arranged to hold momentary snapshots of the recovery unit storage 206. Periodically, a snapshot of the copy of the recovery data in the recovery unit storage 206, is created in the recovery unit 108, allowing fast recovery to almost any point in time. A specific point in time is always available by restoring the most-recent recovery unit snapshot unit and applying the recovery unit journal 202 changes sets that were received after the recovery unit snapshot unit. Thus, in-case of data retrieval to the primary storage, the data can be retrieved of different points in time.

According to an embodiment, the recovery unit 108 may further include a disaster recovery orchestration service to restore the data to a requested point in time and instantiates for example a virtual machine.

Beneficially, in the present disclosure configuration of the local RPO of the CDP unit 100 and the remote RPO of the recovery unit 108 is enabled such that the remote RPO of the recovery unit 108 can be any arbitrary multiple of the local RPO (i.e. how many change sets are consolidated before sending the data to the recovery unit 108). The consolidation allows significant saving of bandwidth. Further, variable RPO is obtained based on the recovery data that is sent from the CDP unit 100 to the recovery unit 108. In an example, a change set may be sent to the recovery unit 108 directly before it is written to the CDP journal unit 106, as a result a low recovery point objective (RPO) is obtained.

The recovery unit and CDP unit of the present disclosure provides improved data backup and retrieval by having variable RPO in for the recovery unit and the CDP unit. The RPO for the CDP unit and the recovery unit may be optimised based on the requirement. The RPO for the recovery unit is varied based on the way data is written to the recovery unit. The data may be sent to the recovery unit directly by the CDP unit to have a low RPO for the recovery unit. Further, the data may be first sent to the CDP journal unit and then read from the CDP journal by applying write coalescing and then the data is sent to the recovery unit to have a higher RPO for the recovery unit. Further, the change set can be read in a consolidated way from the CDP storage unit to enable significant saving of bandwidth. Thus, the present disclosure enables efficient transfer of data from the CDP unit and the recovery unit to the primary storage in-case of data loss in the primary storage.

FIG. 3 is a block diagram that illustrates a data protection assembly, in accordance with an embodiment of the present disclosure. With reference to FIG, 3, there is shown the data protection assembly 300. The data protection assembly 300 comprises the CDP unit 100 and the recovery unit 108. The CDP unit 100 includes the CDP data mover 102, the CDP storage unit 104 and the CDP journal unit 106. The recovery unit 108 includes the recovery unit journal 202, the recovery unit data mover 204 and the recovery unit storage 206.

In another aspect, the present disclosure provides the data protection assembly 300, comprising a CDP unit 100 and a recovery unit 108, wherein the CDP data mover 102 is arranged to forward the recovery data to the recovery unit data mover 204.

The data protection assembly 300 herein refers to a cascaded arrangement of the CDP unit 100 (of FIG. 1) and the recovery unit 108 (of FIG. 2), wherein the CDP data mover 102 of the CDP unit 100 is arranged to forward the recovery data to the recovery unit data mover 204. By virtue of the cascading arrangement, the optimization of the RPO is obtained such that the CDP unit 100 and the recovery unit 108 may have a different (variable) RPO in comparison to conventional data protection systems where RPO cannot be optimized as continuous data protection used conventionally is not configured to be cascaded with a cloud storage.

The CDP unit 100 in the data protection assembly 300 receives the incoming change sets from the primary splitter 110. Further, the CDP data mover 102 of the CDP unit 100 receives the incoming change sets and writes recovery data to the CDP storage unit 104 and the recovery unit data mover 204 of the recovery unit 108. In the data protection assembly 300, the recovery unit 108 and the CDP unit 100 provides improved data backup and retrieval by having variable RPO in for the recovery unit 108 and the CDP unit 100.

According to an embodiment, the CDP data mover 102 creates the recovery data by coalescing data from two or more CDP change sets. The CDP data mover 102 is configured to apply write-coalescing wherein a batch of change sets is consolidated into one change-set that is much smaller than the batch. This significantly reduces the amount of changes and saves bandwidth.

According to an embodiment, the CDP data mover 102 is arranged to forward the incoming data sets to the CDP journal unit 106, and further read one or more of the incoming change sets from the CDP journal unit 106. The temporary storing of the incoming change sets enables the CDP data mover 102 to execute the write-coalescing on the two or more incoming change sets.

According to an embodiment, the CDP unit 100 comprises one or more CDP snapshots of the CDP storage unit 104, each CDP snapshot being a copy of the CDP storage unit 104 at a specific point in time. The CDP data mover 102 creates the recovery data for sending to the recovery unit 108 from at least one of the one or more CDP snapshots. Leveraging snapshots allows reading the data directly from a volume (i.e. data) and not from CDP journal unit.

According to an embodiment, the CDP data mover 102 is arranged to forward the incoming change sets as recovery data to the recovery unit 108. The incoming change sets are forwarded as recovery data to the recovery unit 108 to enable recovery in case of a disaster such as cyber-attacks or data corruption.

There are multiple ways for sending change sets to the recovery unit 108. In an example, a change set may be sent to the recovery unit 108 directly before it is written to the CDP journal unit 106, as a result a low RPO is obtained. In another example, a change set may be sent to the recovery unit 108 after a set of change sets is read from the CDP journal unit 106 and consolidated using write coalescing, parallel to writing the change set to the CDP storage unit 104. In another example, a change set may be read from the CDP snapshot, in this case the change set can be consolidation of several hours of change sets in the CDP journal unit 106.

The recovery unit journal 202 of the recovery unit 108 is configured to receive recovery data from a CDP data mover 102 in the CDP unit 100. Based on the received recovery data, the recovery unit journal 202 is configured to store the log of changes applied to the recovery data. The recovery unit data mover 204 of the recovery unit 108 is arranged to receive the recovery data from the recovery unit journal 202. In other words, the recovery unit data mover 204 reads the recovery data from the recovery unit journal 202 and applies them to a recovery unit replica i.e. the copy of recovery data in the recovery unit 108. The recovery unit storage 206 is arranged to hold a copy of the recovery data. According to an embodiment, the recovery unit 108 further comprises one or more recovery unit snapshot units arranged to hold momentary snapshots of the recovery unit storage 206. Periodically, a snapshot of the copy of the recovery data in the recovery unit storage 206, is created in the recovery unit 108, allowing fast recovery to almost any point in time.

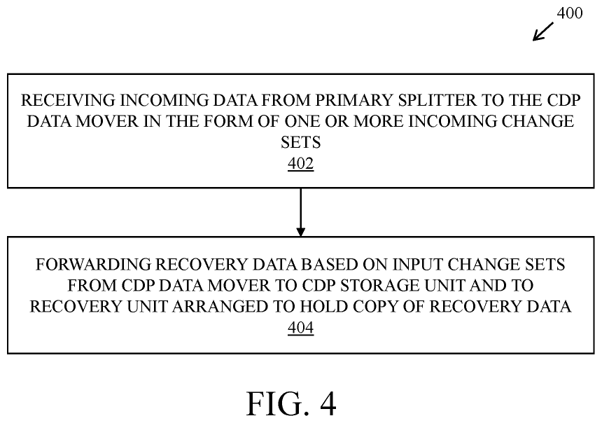

FIG. 4 is a flowchart of a data protection method, in accordance with an embodiment of the present disclosure. With reference to FIG. 4 there is shown the data protection method 400. The data protection method 400 is executed at a CDP unit 100 described, for example, in FIG. 1. The data protection method 400 includes steps 402 and 404.

In another aspect, the present disclosure provides a data protection method 400, involving a CDP unit 100 comprising a CDP data mover 102 and a CDP storage unit 104, said method 400 comprising the steps of: receiving incoming data from a primary splitter 110 to the CDP data mover 102 in the form of one or more incoming change sets; forwarding recovery data based on the input change sets from the CDP data mover 102 to the CDP storage unit 104 and to a recovery unit 108 arranged to hold a copy of the recovery data

At step 402, the data protection method 400 comprises receiving incoming data from a primary splitter 110 to the CDP data mover 102 in the form of one or more incoming change sets. The incoming data are received by the CDP data mover 102 from the primary splitter 110 to enable providing of the continuous data protection services to for example a computing system. The incoming change sets received from the primary splitter 110 are stored and further provided to the computing system when needed.

At step 404, the data protection method 400 comprises forwarding recovery data based on the input change sets from the CDP data mover 102 to the CDP storage unit 104 and to a recovery unit 108 arranged to hold a copy of the recovery data. The incoming change sets that are received by the CDP unit 100 is forwarded as recovery data to enable recovering data in case of any data corruption, hardware or software failure in the primary storage, accidental deletion of data, hacking, or malicious attack. The recovery data is forwarded to the CDP storage unit 104 and to a recovery unit 108 to enable variable RPO for CDP unit 100 and the recovery unit 108, and further enables a significant saving of bandwidth. In the data protection method 400, the recovery unit 108 and the CDP unit 100 provides improved data backup and retrieval by having variable RPO in for the recovery unit 108 and the CDP unit 100.

According to an embodiment, the data protection method 400 comprises the step of coalescing, in the CDP data mover 102 data from two or more input change sets to create the recovery data. The step of write-coalescing is applied on two or more input change sets by consolidating the two or more input change sets into one change-set that is much smaller than the batch. Beneficially, if a particular block range is overwritten multiple times, only the most recent written data is used to create the recovery data. This significantly reduces the amount of changes and saves bandwidth.

create the recovery data. This significantly reduces the amount of changes and saves bandwidth.

According to an embodiment, the data protection method 400 comprises writing the incoming change sets from the CDP data mover 102 to the CDP journal unit 106, reading one or more of the incoming change sets from the CDP journal unit 106 by the CDP data mover 102, creating, in the CDP data mover 102, the recovery data based on the one or more incoming change sets read from the CDP journal unit 106. Based on the received incoming change sets, the CDP journal unit 106 stores the log of changes applied to the incoming data change sets. The writing and reading of incoming change sets from CDP journal unit 106 enables in executing the write-coalescing on the one or more incoming change sets. Based on the recovery data received from the CDP journal unit 106, write-coalescing is executed and recovery data is created for sending to the recovery unit 108. As a result, there is significant saving of bandwidth for the CDP unit.

According to an embodiment, in the data protection method 400, the CDP unit 100 further comprises one or more snapshots of the CDP storage unit 104, each CDP snapshot being a copy of the CDP storage unit 104 at a specific point in time, the method 400 further comprising the steps of reading, by the CDP data mover 102, at least one of the snapshots and creating the recovery data based on data from at least one snapshot, for example by determining the difference between two snapshots taken at different points in time or calculating the difference between the last copy of the recovery unit snapshot unit arriving at the recovery unit 108 and the CDP snapshot. The last copy can be a CDP snapshot instead of the recovery unit snapshot unit if the data is sent in a continuous way. The CDP snapshot allows recovery to multiple points in time. The CDP snapshots are read and recovery data is created by the CDP data mover 102 for sending to the recovery unit 108. In an example, the difference between two snapshots taken at different points in time enable in creating the recovery data having the changes or changed incoming data. Leveraging snapshots allows reading the data directly from a volume (i.e. data) and not from CDP journal unit 106. The CDP unit 100 can consolidate data for several hours and then send to the recovery unit 108 to enable saving of bandwidth.

The steps 402 to 404 are only illustrative and other alternatives can also be provided where one or more steps are added, one or more steps are removed, or one or more steps are provided in a different sequence without departing from the scope of the claims herein.

In another aspect, provided is a computer program product for controlling a CDP storage unit 104 comprising computer-readable code means which, when executed in a control unit 112 will cause the control unit 112 to control the CDP storage unit 104 to perform the method 400. The computer program product for controlling a CDP storage unit 104 comprises a non-transitory computer-readable storage medium having computer-readable code means being executable by the control unit 112 to execute the method 400. By virtue of the computer program product, the CDP unit 100 and the recovery unit 108 provides improved data backup and retrieval by having variable RPO in for the recovery unit 108 and the CDP unit 100.

In another aspect, provided is a computer program product for controlling a data protection assembly 300 comprising computer-readable code means which, when executed in a control unit 112 will cause the control unit 112 to control the CDP storage unit 104 to perform the method 400. The computer program product for controlling a data protection assembly 300 comprises a non-transitory computer-readable storage medium having computer-readable code means being executable by a control unit 112 to execute the method 400. By virtue of the computer-readable code in the computer program product, the CDP unit 100 and the recovery unit 108 provides improved data backup and retrieval by having variable RPO in for the recovery unit 108 and the CDP unit 100. Examples of implementation of the non-transitory computer-readable storage medium include, but is not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, or CPU cache memory.

The control unit 112 for a CDP storage unit 104 comprises a program memory 114 holding the computer program product. The program memory 114 includes suitable logic, circuitry, and interfaces that may be configured to store the computer program product. By virtue of the program memory 114 holding the computer program product in control unit 112, the CDP unit 100 and the recovery unit 108 provides improved data backup and retrieval by having variable RPO in for the recovery unit 108 and the CDP unit 100. Examples of implementation of the program memory 114 may include, but are not limited to, Electrically Erasable Programmable Read-Only Memory (EEPROM), Random Access Memory (RAM), Read Only Memory (ROM), Hard Disk Drive (HDD), Flash memory, Solid-State Drive (SSD), or CPU cache memory.

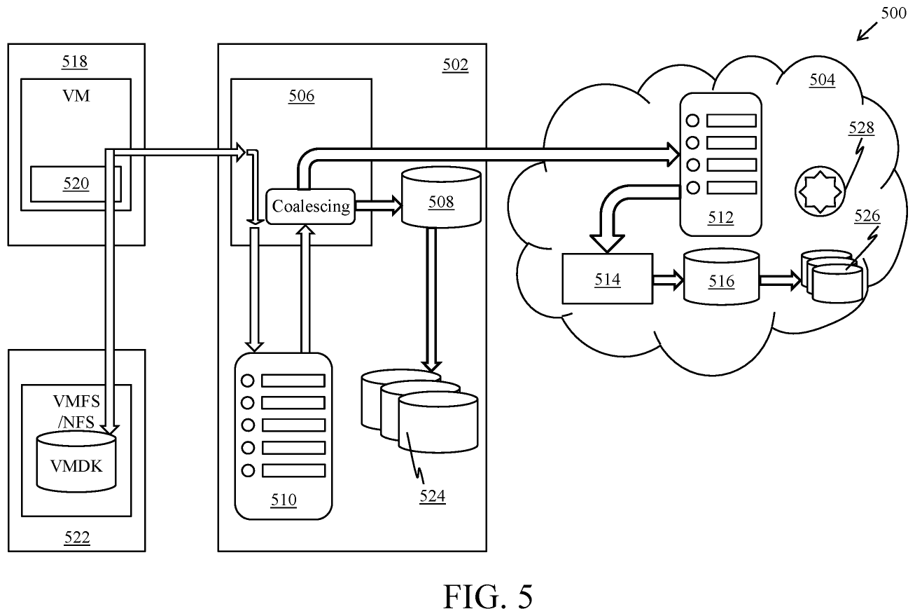

FIG. 5 is an illustration of a data protection assembly, in accordance with an embodiment of the present disclosure. With reference to FIG, 5, there is shown the data protection assembly 500. The data protection assembly 500 comprises a CDP unit 502 and a recovery unit 504. The CDP unit 502 includes the CDP data mover 506, the CDP storage unit 508 and the CDP journal unit 510. The recovery unit 504 includes the recovery unit journal 512, the recovery unit data mover 514 and the recovery unit storage 516. There is further shown a hypervisor 518, a primary splitter 520 and a primary storage 522.

The primary splitter 520 is configured to provide to the CDP unit 502 a copy of incoming data sent to the primary storage 522 in the form of incoming change sets. The primary splitter 520 is installed in a virtual machine (VM) on the hypervisor 518. The incoming sets are sent to a virtual machine disk (VMDK) in the virtual machine file system (VMFS) or a network file system (NFS) of the primary storage 522.

The CDP data mover 506 is arranged to receive the incoming change sets and write recovery data based on one or more change sets to the CDP storage unit 5o8 and to the recovery unit 504 arranged to hold a copy of the recovery data.

According to an embodiment, the CDP data mover 506 is arranged to create the recovery data by coalescing data from two or more CDP change sets. According to an embodiment, the CDP journal unit 510 is arranged to temporarily store the incoming change sets, wherein the CDP data mover 506 is arranged to forward the incoming data sets to the CDP journal unit 510, the CDP data mover 506 being further arranged to read one or more of the incoming change sets from the CDP journal unit 510 and the recovery data is based on the one or more CDP change sets. According to an embodiment, the CDP unit 502 comprises one or more CDP snapshots 524 of the CDP storage unit 508, each CDP snapshot being a copy of the CDP storage unit 508 at a specific point in time, wherein CDP data mover 506 is arranged to create the recovery data based on data from at least one of said one or more CDP snapshots 524. According to an embodiment, the CDP data mover 506 is arranged to forward the incoming change sets as recovery data to the recovery unit 504.

The recovery unit journal 512 is configured to receive recovery data from a CDP data mover 506 in a CDP unit 502. The recovery unit data mover 514 is arranged to receive the recovery data from the recovery unit journal 512. The recovery unit storage 516 is arranged to hold a copy of the recovery data.

According to an embodiment, the recovery unit 504 further comprises one or more recovery unit snapshot units 526 arranged to hold momentary snapshots of the recovery unit storage 516. According to an embodiment, the recovery unit 504 may further include a disaster recovery orchestration service 528 to restore the data to a requested point in time and instantiates for example a virtual machine.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

1.8. (canceled)

9. A method, comprising:
receiving, by a continuous data protection (CDP) data mover, incoming data from a primary splitter in a form of one or more incoming change sets
forwarding, by the CDP data mover, recovery data based on the one or more incoming change sets to a CDP storage and to a recovery storage arranged to hold a copy of the recovery data.

10. The method according to claim 9, comprising:
coalescing, in the CDP data mover, data from two or more incoming change sets to create the recovery data.

11. The method according to claim 9, further comprising:
writing, by the CDP data mover, the one or more incoming change sets to a CDP journal file,
reading, by the CDP data mover, at least one of the one or more incoming change sets from the CDP journal file; and
creating, in the CDP data mover, the recovery data based on the at least one of the one or more incoming change sets read from the CDP journal file.

12. The method according to claim 9, further comprising:
reading, by the CDP data mover, at least one snapshot of one or more snapshots of the CDP storage, each CDP snapshot being a copy of the CDP storage at a respective point in time; and
creating the recovery data based on data from at least one snapshot.

13. A device, comprising:
an interface; and
a processor, configured to:
receive incoming data through the interface from a primary splitter to a continuous data protection (CDP) data mover in a form of one or more incoming change sets; and
forward recovery data based on the one or more incoming change sets from the CDP data mover to a CDP storage and to a recovery storage arranged to hold a copy of the recovery data.

14. The device according to claim 13, wherein the processor is further configured to:
coalesce, in the CDP data mover, data from two or more incoming change sets of the one or more incoming change sets to create the recovery data.

15. The device according to claim 13, wherein the processor is further configured to:
write the one or more incoming change sets from the CDP data mover to a CDP journal file;
read at least one of the one or more incoming change sets from the CDP journal file by the CDP data mover; and
create, in the CDP data mover, the recovery data based on the at least one of the one or more incoming change sets read from the CDP journal file.

16. The device according to claim 13, wherein the processor is further configured to:
read at least one snapshot of one or more snapshots of the CDP storage, and create the recovery data based on data from the at least one snapshot, each CDP snapshot being a copy of the CDP storage at a respective point in time.

17. A non-transitory computer readable storage medium storing a program that is executable by at least one processor, the program including instructions for:
receiving incoming data through an interface from a primary splitter in a form of one or more incoming change sets from a continuous data protection (CDP) mover; and
forwarding recovery data based on the one or more incoming change sets from the CDP data mover to a CDP storage and to a recovery storage arranged to hold a copy of the recovery data.

18. The non-transitory computer readable storage medium according to claim 17, wherein the program further includes instructions to:
coalesce, in the CDP data mover, data from two or more incoming change sets of the one or more incoming change sets to create the recovery data.

19. The non-transitory computer readable storage medium according to claim 17, wherein the program further includes instructions to:
write the one or more incoming change sets from the CDP data mover to a CDP journal file;
read at least one of the one or more incoming change sets from the CDP journal file by the CDP data mover; and
create, in the CDP data mover, the recovery data based on the at least one of the one or more incoming change sets read from the CDP journal file.

20. The non-transitory computer readable storage medium according to claim 17, wherein the program further includes instructions to:
read at least one snapshot of one or more snapshots of the CDP storage, and create the recovery data based on data from the at least one snapshot, each CDP snapshot being a copy of the CDP storage at a respective point in time.
